(19) United States
(12) Patent Application Publication
(10) Pub. No.: US 2025/0138492 A1
(43) Pub. Date: May 1, 2025

(54) CHARGE-DISCHARGE METHOD, ELECTRONIC DEVICE, AND NON-TRANSITORY STORAGE MEDIUM

(71) Applicants: HONGFUJIN PRECISION INDUSTRY (WUHAN) CO., LTD., Wuhan (CN); HON HAI PRECISION INDUSTRY CO., LTD., New Taipei (TW)

(72) Inventor: CHI-YU CHANG, New Taipei, NY (US)

(21) Appl. No.: 18/541,173

(22) Filed: Dec. 15, 2023

(30) Foreign Application Priority Data
Nov. 1, 2023 (CN) 202311452457.1

(51) Int. Cl. G05B 13/02

(52) U.S. Cl. CPC G05B 13/028

(57) ABSTRACT

A charge-discharge method applied to an electronic device for controlling a charging and a discharging of a vehicle, the electronic device communicates with a charging pile. The charge-discharge method comprises collecting operation behavior information of a user with respect to household appliances, inputting the operation behavior information into a preset travel time prediction model to obtain a first driving travel time of the user, determining a first charge-discharge strategy of the vehicle of the user based on the first driving travel time, and transmitting the first charge-discharge strategy to the charging pile. The charging pile charges the vehicle or controls the vehicle to discharge based on the first charge-discharge strategy. An electronic device and a non-transitory storage are also disclosed.

### FIELD

The subject matter herein generally relates to vehicle charge-discharge field.

### BACKGROUND

New energy vehicles have many advantages of fast start, zero emission, low noise, and low energy consumption with a development of new energy technology. New energy vehicles are gradually recognized by the market and favored by consumers.

However, new energy vehicles charges using a fixed charge-discharge model, and the fixed charge-discharge model is not flexible and cannot meet requirements of users.

For example, when the user needs to go out immediately, the vehicle using a charge model with slow charging speed to charge, which would cause electric power of the vehicle not sufficient. On the other hand, if the charging speed of the vehicle is too faster, or a situation of over-charging or over-discharge will cause a battery life of the vehicle to be greatly shortened.

### BRIEF DESCRIPTION OF THE DRAWINGS

Implementations of the present disclosure will now be described, by way of embodiments, with reference to the attached figures.

FIG. 1 is a schematic diagram illustrating an application scenario of a charge-discharge system according to an embodiment of the present disclosure.

FIG. 2 is a flowchart illustrating a charge-discharge method according to an embodiment of the present disclosure.

FIG. 3 is a sub-block flow diagram illustrating block 202 in FIG. 2 according to an embodiment of the present disclosure.

FIG. 4 is a block flow diagram illustrating retraining a travel time prediction model according to an embodiment of the present disclosure.

FIG. 5 is a sub-block flow diagram illustrating block 203 in FIG. 2 according to an embodiment of the present disclosure.

FIG. 6 is a diagram showing modules illustrating an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to;” it specifically indicates open-ended inclusion or membership in the so-described combination, group, series, and the like.

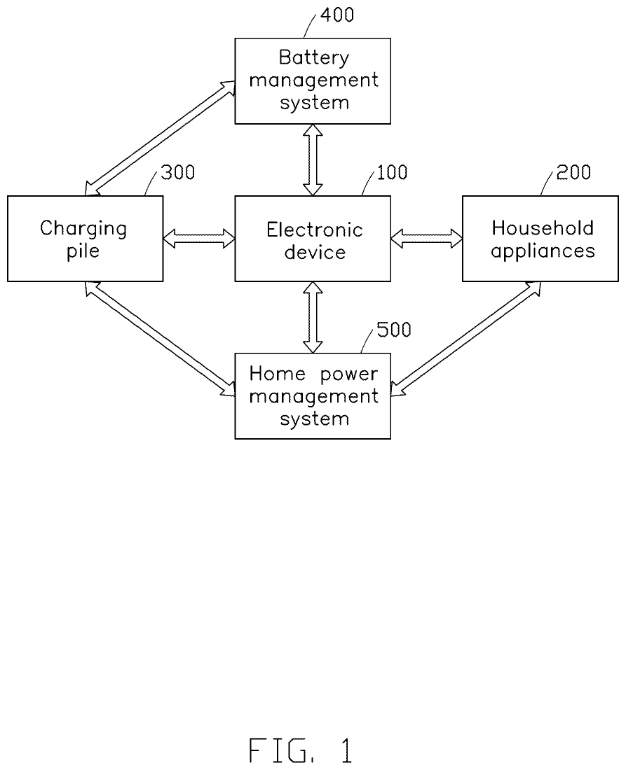

Referring to FIG. 1, a charge-discharge system includes an electronic device 100, household appliances 200, and a charging pile 300. The electronic device 100 communicates with the household appliances 200 and the charging pile 300. The household appliances 200 includes terminals for personal use or other appliances. For example, the household appliances 200 may include mobile phones, computers, air conditioners, washing machines, hair dryers, etc.

The electronic device 100 is configured to perform a charge-discharge method. The charge-discharge method may include: collecting operation behavior information of a user with respect to the household appliances 200, inputting the operation behavior information into a preset travel time prediction model to obtain a first driving travel time of the user, determining a first charge-discharge strategy of a vehicle of the user based on the first driving travel time, and transmitting the first charge-discharge strategy to the charging pile 300, the charging pile 300 charges the vehicle or control the vehicle to discharge based on the first charge-discharge strategy.

In some embodiments, the vehicle includes a battery pack, the charging pile 300 can charge the battery pack of the vehicle based on the first charge-discharge strategy. The charging pile 300 may transmit the first charge-discharge strategy to the vehicle, and the battery pack of vehicle is discharged based on the first charge-discharge strategy. The charging pile 300 may also control the battery pack of vehicle to discharge based on the first charge-discharge strategy.

In some embodiments, the electronic device 100 may directly transmit the first charge-discharge strategy to the vehicle, and the battery pack of vehicle is discharged based on the first charge-discharge strategy.

In some embodiments, the electronic device 100 can be an integrated home control device, the integrated home control device collects the operation behavior information of the user with respect to the household appliances 200. The electronic device 100 communicates with the household appliances 200. The integrated home control device can adopt an edge computing technology or an Internet of Things (IoT) technology to communicate with the household appliances 200. The edge computing technology can improve a security of the operation behavior information and protect privacies of users.

In some embodiments, referring to FIG. 1, the charge-discharge system further includes a storage device, the storage device stores charge-discharge data of the vehicle. For example, the storage device includes a battery management system 400 and a home power management system 500. The electronic device 100 can collect the charge-discharge data of the vehicle from the storage device.

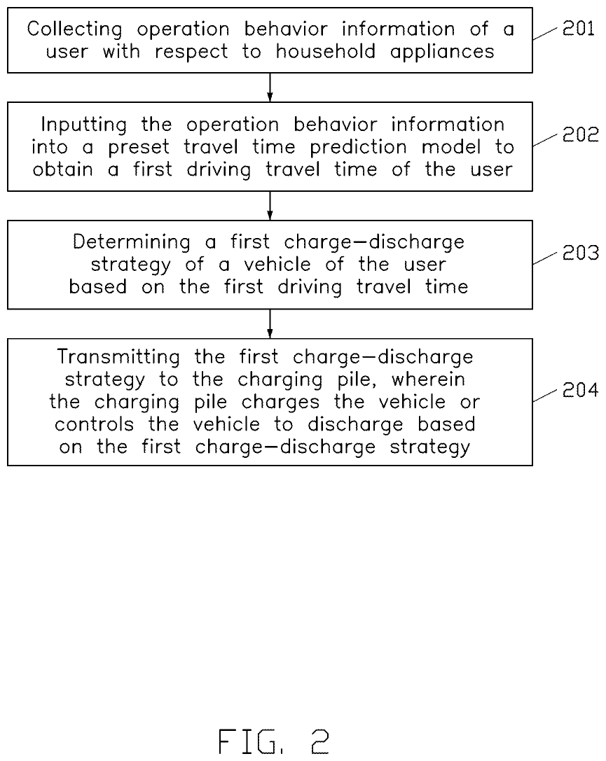

FIG. 2 illustrates one exemplary embodiment of a charge-discharge method. The flowchart presents an exemplary embodiment of the method. The exemplary method is provided by way of example, as there are a variety of ways to carry out the method. Each block shown in FIG. 2 may represent one or more processes, methods, or subroutines, carried out in the example method. Furthermore, the illustrated order of blocks is illustrative only and the order of the blocks can change. Additional blocks can be added, or fewer blocks may be utilized, without departing from this disclosure.

The charge-discharge method is used for the electronic device 100. The electronic device 100 communicates with the charging pile 300. The example method can be begun at block S201.

In block S201, the operation behavior information of the user with respect to the household appliances is collected.

In one embodiment, the operation behavior information describes an operation of users with respect to the household appliances 200. The operation behavior information includes at least one operation data of the user with respect to the household appliances 200. The household appliances 200 include an alarm clock, a television, a flat panel, a refrigerator, and a hair dryer, etc. Data of the household appliances 200 can be configured to predict some driving travel time for users.

For example, if the household appliance 200 is the alarm clock. First operation data describes a journey of the user. The first operation data may include a wake-up alarm time. A time between getting up and going out of a house generally fluctuates with a certain range. The driving travel time can be predicted by a time of the wake-up alarm time of the user.

If the household appliance 200 is the television. Second operation data describes a TV viewing habit of the user. The second operation data may include a TV viewing time of the user, and a viewing content. The user has a habit of going out every morning after watching news or weather shows. The driving travel time is predicted by the second operation data.

If the household appliance 200 is the flat panel. The user may input family-related expenses, inventory of daily necessities, family schedules, scheduled driving trips, and appointments on a tablet. Fourth operation data is data of family-related expenses, inventory of daily necessities, family schedules, scheduled driving trips, and appointments on a tablet. The fourth operation data can reflect the driving travel time of the user.

If the household appliance 200 is the refrigerator. Fifth operation data includes a time that family members have taken or stored foods from the refrigerator, and the number of foods remaining in the refrigerator. The user regularly drink fresh milk before going out in the morning and check the ingredients in the refrigerator before cooking dinner. The user also go out to purchase foods when foods are not enough. The fifth operation data can reflect the driving travel time of the user.

If the household appliance 200 is the hair dryer. Sixth operation data includes a hair blow-out time of the user. For example, the user blows his hair before going out, or the user blows his hair after taking a shower. If the user blows his hair before going out, the user will drive a car after minutes. If the user blows his hair after just driving back, the user blows his hair after taking a bath, and the user will not go out again for a long time.

The operation data of the household appliance 200 can be transmitted to the electronic device 100 by wired or wireless means, the electronic device 100 can estimate the driving travel time of the user. The charge-discharge strategy can be formulated according to the driving travel time of the user to meet the user's home time and travel time.

In other embodiments, the electronic device 100 can also communicate with water heaters, air conditioners, lights, and electric fans, etc.

After obtaining the operation behavior information, the electronic device 100 can also preprocess the operation behavior information, the operation behavior information meets a format requirement of the travel time prediction model for input data. When the operation data does not meet a preset travel time evaluation condition, the operation data is removed from the operation behavior information. The operation data is generated by people who do not have the right to drive (such as guests, minors, etc.). If the operation data does not meet the preset travel time evaluation conditions, the operation data cannot reflect the user's driving travel time, the operation data is removed. The travel time prediction model can improve an accuracy of estimating users' travel time.

In block S202, the operation behavior information is input into the preset travel time prediction model to obtain the first driving travel time of the user.

In one embodiment, the travel time prediction model describes a relationship between the operation behavior information of the user and the first driving travel time of the user. The travel time prediction model can be an artificial intelligence model, and the artificial intelligence model can be trained based on the historical operation behavior information of the user to obtain the user's habits, and then obtain the relationship between each operation behavior information and the first driving travel time of the user.

In other embodiments, the travel time prediction model can also be a data table. The data table stores a mapping relationship between each type of operation data in the operation behavior information and the first drive travel time.

For example, if the operation behavior information includes a type of operation data of a scheduled reminder, the operation data of the scheduled reminder indicates that the alarm clock rings at 7 a.m., and the travel time prediction model indicates that the user generally leaves the house between 50 and 60 minutes after the alarm clock rings, and the first driving travel time of the user can be predicted between 7:50 and 8:00.

In one embodiment, when the operation information includes one operation data, the travel time prediction model can predict the first driving travel time based on the operation data. When the collected operation behavior information includes multiple operation data, the travel time prediction model can select one operation data among the multiple operation data. For example, each operation data has priority, the operation data is selected with higher priority to be an object operation data, the first driving travel time is predicted based on the object operation data.

For example, the operation behavior information includes the alarm clock and refrigerator switch data, and a priority of the alarm clock is higher than the refrigerator switch data, and the first driving travel time can be predicted based on the alarm clock.

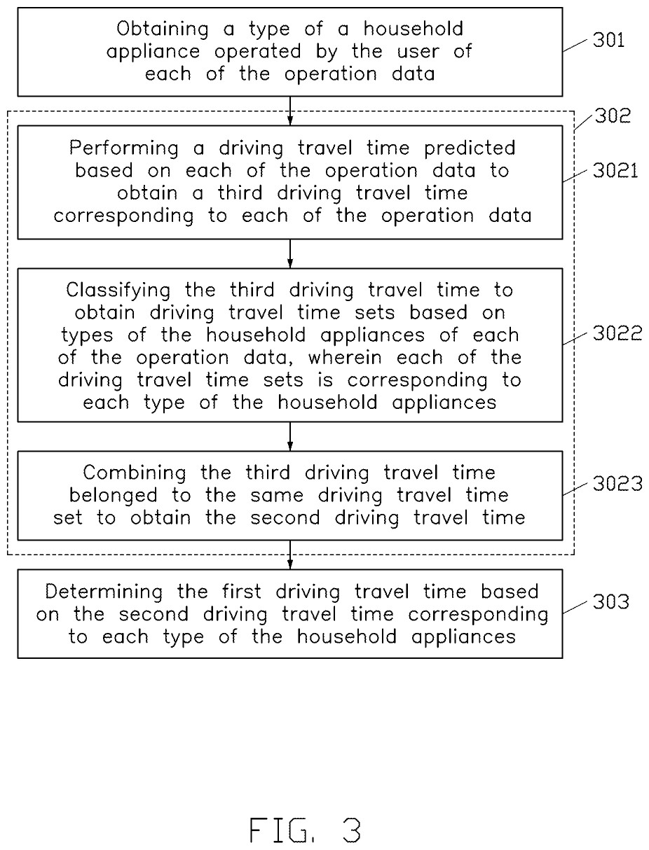

In another embodiment, referring to FIG. 3, when the operation behavior information includes multiple operation data, the preset travel time prediction model can perform the following blocks (block S301˜block S303).

In block S301, a type of a household appliance 200 operated by the user of each of the operation data is obtained.

In one embodiment, the travel time prediction model can include a classification module. The classification module is an artificial intelligence model. The electronic device 100 can input the operation data into the classification module, and the classification module can separately calculate some probabilities. One probability is a value of the operation data for each type of the household appliances 200. Then, types of the household appliances 200 operated by the operation data is determined based on some probabilities.

For example, types of household appliances 200 include a type A, a type B, and a type C. The classification module calculates some probabilities based on the operation data data 1. A probability of the type A of the household appliances 200 operated by the operation data data 1 is pA, a probability of the type B of the household appliances 200 operated by the operation data data 1 is pB, a probability of the type C of the household appliances 200 operated by the operation data data 1 is pC. A maximum value can be selected in pA, pB, and pC, a type of the household appliance 200 corresponding to the maximum value is taken as the type of the household appliance 200 operated by the operation data.

In some embodiments, pA, pB, and pC are compared with a certain threshold, and the type of the household appliance 200 corresponding to the probability of exceeding the threshold is taken as the type of the household appliance 200 operated by the operation data.

Types of the household appliances 200 can be divided according to some functions provided by the household appliances 200. For example, types of household appliances 200 can include hair dryers, refrigerators, air conditioners, household appliances 200 can provide schedule reminders, such as flat panels, and flat panels can provide timing functions, such as alarm clocks. Some household appliances 200 can provide a variety of functions, and the type of the household appliances 200 operated by the operation data can be determined based on the function provided by the household appliances 200 when the operation data is operated.

For example, the user can input a planned schedule on a tablet, such as going out for an appointment at a certain time, and the type of the household appliance 200 operated by the operation data is the appliance that provides the schedule reminder. The tablet can also provide alarm function, such as the alarm clock at 7:00 a.m., the type of the household appliances 200 operated by the operation data is an appliance that provides timing function.

In block S302, a second driving travel time corresponding to each type of the household appliances is predicted, based on the operation data of the same type of the household appliances.

For example, the user has set the alarm clock at 7:00 and the alarm clock at 7:30 in the morning. The operation behavior information includes two operation data of the 7:00 a.m. bell and the 7:30 a.m. bell. The second driving travel time corresponding to the household appliances 200 with timing function can be predicted based on two operation data of the 7:00 a.m. bell and the 7:30 a.m. bell.

If the operation behavior information also includes the user's hair blow-drying at 7:10, the hair drying time is 5 minutes. The electronic device 100 can predict the second driving travel time corresponding to the hair dryer based on the operation data.

In some embodiments, the block S302 can include some blocks (block S3021˜block S3023).

In block S3021, the driving travel time based on each of the operation data is performed to obtain a third driving travel time corresponding to each of the operation data.

For example, after the alarm bell rings in the morning based on the travel time prediction model, the user generally drives an hour later. The third driving travel time based on the operation data of the 7:00 a.m. bell is 8:00 o'clock, and the third driving travel time based on the operation data of the 7:30 a.m. bell is 8:30 o'clock.

In block S3022, the third driving travel time is classified to obtain driving travel time sets based on types of the household appliances of each of the operation data, each of the driving travel time set is corresponding to each type of the household appliances.

If multiple operation data are used to operate the same type of the household appliances 200, the third driving travel time is predicted based on the multiple operation data belongs to the same driving travel time set.

In block S3023, the third driving travel time belonged to the same driving travel time set is combined to obtain the second driving travel time.

For example, in the third driving travel time belonging to the same driving travel time set, the earliest or the latest time point can be selected as the second driving travel time corresponding to each type of household appliances 200.

For example, the driving travel time set based on a ringing time includes 8:00 o'clock and 8:30 o'clock. If the user uses the hairdryer at 7:10 o'clock, the user may get up at 7:00 o'clock when the bell rings. Therefore, 8:00 o'clock can be the second driving travel time.

In block S303, the first driving travel time is determined based on the second driving travel time corresponding to each type of the household appliances.

In some embodiments, a weight corresponding to each type of the household appliances 200 is obtained, the first driving travel time is obtained based on the second driving travel time corresponding to each type of the household appliances 200 and the weight corresponding to each type of the household appliances 200.

The weight of each type of the household appliances 200 can be set according to demand. For example, the weight of the appliance that provides schedule reminder is higher than the weight of the appliance with timing function.

Further, in some weights corresponding to each type of household appliances 200, the type of household appliance 200 with the largest weight is determined, and the second driving travel time corresponding to the type of household appliance 200 is as the first driving travel time.

For example, the weight of a schedule reminder appliance is the highest, and the second driving travel time corresponding to the type of appliance is the first driving travel time. The weight corresponding to each type of household appliances 200 and the second driving travel time corresponding to each type of household appliances 200 are weighted and summed to get the first driving travel time.

In some embodiments, after the electronic device 100 collected operation behavior information of the user with respect to household appliances 200, the travel time prediction model is retrained based on a newly collected operation behavior information. The newly collected operation behavior information includes at least one operation data of the household appliance 200 of the user.

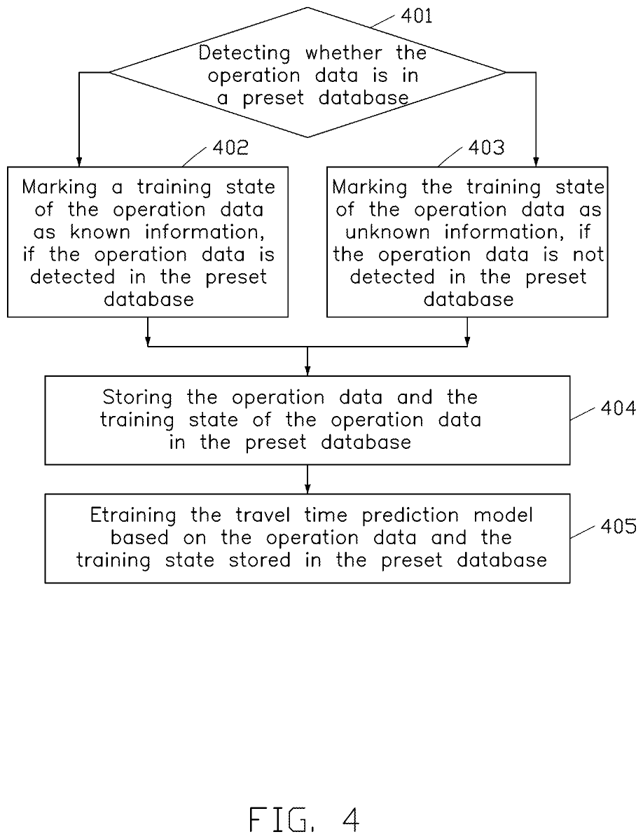

Referring to FIG. 4, retraining blocks of the travel time prediction model includes block S401˜block S405.

In block S401, the operation data collected by the household appliances of the user is detected for existence in a preset database.

The preset database comprises a sample for training the travel time prediction model. If the operational data is detected in the preset database, the training data set of the travel time prediction model includes the operation data, and the travel time prediction model has been trained on the operation data. The block S402 is performed.

If the operational data is not detected in the preset database, the training data set of the travel time prediction model does not include the operation data, and the travel time prediction model has been not trained on the operation data. The block S403 is performed.

In block S402, a training state of the operation data is marked as known information, if the operation data is detected in the preset database.

In block S403, a training state of the operation data is marked as unknown information, if the operation data is not detected in the preset database.

In block S404, the operation data and the training state of the operation data is stored in the preset database.

In block S405, the travel time prediction model is retrained, based on the operation data and training state stored in the preset database.

For example, the travel time prediction model is retrained by a deep learning approach, the operation behavior information and training state stored in the preset database. Training algorithms used by the known information and the unknown information are different. A retraining of the known information can improve the accuracy of the travel time prediction model for the type of operation data. A retraining of the unknow information can improve the diversification of the types of operational data that the travel time prediction model can handle.

After the first driving travel time is obtained, the block S203 is performed.

In block S203, a first charge-discharge strategy of the vehicle is determined based on the first driving travel time.

The first driving travel time can reflect a time that the vehicle can charge at the charging pile 300. The first charge-discharge strategy can reflect a charging time, a discharging time, electrical parameters used for charging. For example, the electrical parameters are voltage, current, power, total charge amount, etc.

In some embodiments, the electronic device 100 can establish a constrained optimization model, the constrained optimization model takes the charge-discharge strategy as a decision variable, and a maximum battery life under the charge-discharge strategy is an objective function. The constraint condition is a total power required by the user for driving, when the battery of the vehicle uses the charge-discharge strategy, before the first driving travel time. The first charge-discharge strategy is obtained by solving the constrained optimization model.

Further, the constraint condition can include a maximum voltage and current.

In some embodiments, the electronic device 100 can obtain the second charge-discharge strategy. The second charge-discharge strategy is adjusted to obtain the first charge-discharge strategy, based on the first driving travel time. The first driving travel time and the second driving travel time are combined to obtain the first charge-discharge strategy, the requirement of the user on the vehicle endurance can be met.

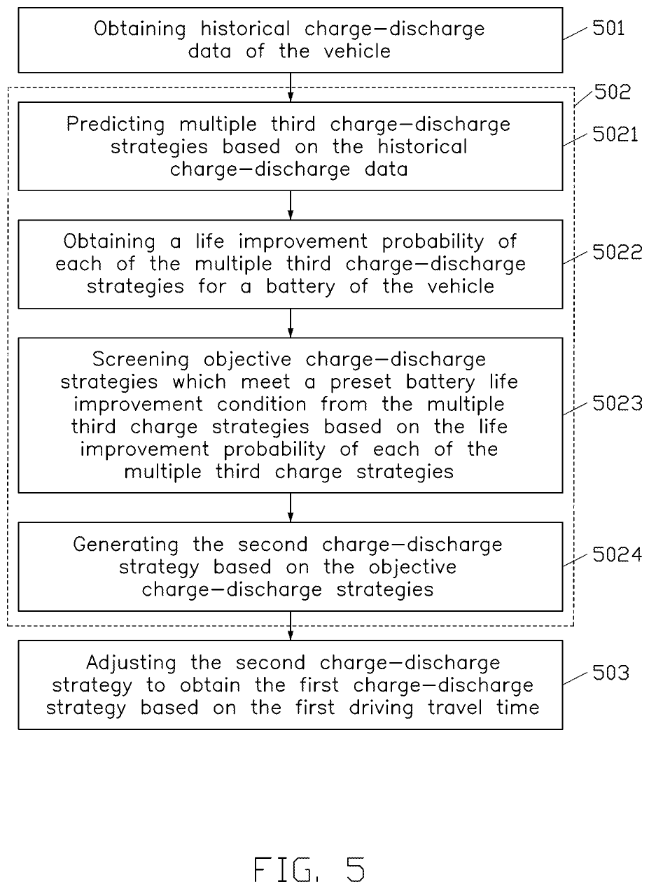

For example, referring to FIG. 5, the block S203 can further include some blocks (block S501˜block S503).

In block S501, historical charge-discharge data of the vehicle is obtained.

Referring to FIG. 1, the electronic device 100 can obtain the historical charge-discharge data from the battery management system 400, the home power management system 500 and/or the charging pile 300. The historical charge-discharge data can describe a relationship between a capacity of the battery and a change of time, as well as the current, voltage, and power of the charge-discharge of the battery of the vehicle.

In some embodiments, after the historical charge-discharge data is obtained, a format of the charge-discharge data can be preprocessed, the charge-discharge data can meet a preset format of the charge-discharge data to facilitate a charge-discharge strategy formulation model to process the charge-discharge data. For example, the charge-discharge data is presented in a form of a charge-discharge curve, and a horizontal coordinate of the charge-discharge curve can be time, and a vertical coordinate can be the current, voltage and capacity of the battery.

Some curve fragments that do not extend battery life, such as fast charging and short charging, are removed from the charge-discharge curve. The obtaining charge-discharge data can improve the battery life of the vehicle, and the charging/discharging strategy can be formulated.

After collecting the historical charge-discharge data of the vehicle, the preset charge-discharge strategy formulation model can be retrained based on the newly collected historical charge-discharge data to improve the accuracy of the charge-discharge strategy formulation model.

In block S502, the historical charge-discharge data is input into the preset charge-discharge strategy formulation model to obtain the second charge-discharge strategy of the vehicle.

The charge-discharge strategy formulation model can be the artificial intelligence model. The charge-discharge strategy formulation model can perform some blocks, for example, block S5021˜block S5024.

In block S5021, multiple third charge-discharge strategies are predicted based on the historical charge-discharge data.

In one embodiment, the historical charge-discharge data can reflect a relationship between the voltage, current and capacity of the battery in the history of the vehicle and the change of time. The third charge-discharge strategy can describe the charging time and the discharging time. The charge-discharge strategy can be presented in the form of charge-discharge curves. For example, the historical charge-discharge data can include multiple historical charge-discharge curves, the third charge-discharge strategy is formed by the electronic device 100 based on the combination of multiple charge-discharge curves.

In block S5022, a life improvement probability of each of the multiple third charge-discharge strategies for a battery of the vehicle is obtained.

The battery life improvement probability created by different third charge/discharge strategies is different, the life improvement probability of each charge-discharge strategy can be calculated based on the charge-discharge strategy.

In block S5023, objective charge-discharge strategies which meet a preset battery life improvement condition from the multiple third charge strategies is screened based on the life improvement probability of each of the multiple third charge strategies.

The preset battery life improvement condition includes the life improvement probability exceeding a preset probability threshold, or the third charge-discharge strategy ranked in the top several in the probability of life improvement.

In block S5024, the second charge-discharge strategy is generated based on the objective charge-discharge strategy.

In some embodiments, the electronic device 100 can organize and combine the third charge-discharge strategy. For example, in the second charge-discharge strategy, the electronic device 100 charges by one third charge-discharge strategy in a certain time period, and the electronic device 100 charges by another third charge-discharge strategy in another time period.

In other embodiments, the voltage and current of the third charge-discharge strategy at each time period are weighted average processing to obtain the second charge-discharge strategy, and the third charge-discharge strategy meets the preset battery life improvement conditions. The second charge-discharge strategy can guarantee the battery life of the vehicle.

In block S503, the second charge-discharge strategy is adjusted to obtain the first charge-discharge strategy, based on the first driving travel time.

For example, in the second charge-discharge strategy, the battery of the vehicle is charged for eight hours, but the first driving travel time is six hours later. The electronic device 100 can perform a comprehensive calculation of the first driving travel time and the second charge-discharge strategy to obtain the first charge-discharge strategy. For example, the second charge-discharge strategy is modified based on the first driving travel time, a charging completion time is advanced to five hours and forty five minutes to meet the user's driving requirements.

The first driving travel time is combined with the second charge-discharge strategy to obtain the first charge-discharge strategy, the battery of the vehicle is charged by the first charge-discharge strategy to meet the requirement of the vehicle endurance, a negative impact of the charge-discharge process on battery life is also reduced.

In some embodiments, a real-time electricity price is obtained, and the second charge-discharge strategy is adjusted to obtain the first charge-discharge strategy, based on the first driving travel time and the real-time electricity price.

The electronic device 100 can adjust a charging period of the second charge-discharge strategy to a time period with lower electricity price in the real-time electricity price, and the time period is before the first driving travel time to obtain the first charge-discharge strategy. The electronic device 100 can also add a discharge period in the second charge-discharge strategy, the vehicle can supply power to household appliances, and the discharge period is in the time period of higher electricity price in the real-time electricity price. The electronic device 100 can reduce the charge-discharge cost of vehicles.

For example, the electronic device 100 can select the period of low real-time electricity price before the first driving travel time as the charging period of the second charge-discharge strategy, and the first charge-discharge strategy of the vehicle is obtained.

For example, the first drive travel time illustrates the user's drive after ten hours, during ten hours, the real-time electricity price is: an electricity price of 0˜5 hours is 0.8 RMB per hour, and an electricity price of 5˜10 hours is 0.5 RMB per hour. The second charge-discharge strategy illustrates the battery of the vehicle is charged from 0˜5 hours. The electronic device 100 can adjust the charging time of the second charge-discharge strategy to charge in the period of 5˜10 hours to save electricity.

In other embodiments, a current time is long from the first driving travel time, the electronic device 100 can discharge in the period of high electricity price before the first driving travel time, the electronic device 100 provides electrical energy for the household appliance 200. The electronic device 100 charges in the period of low electricity price. The electronic device 100 can adjust the charge-discharge curve of the second charge-discharge strategy to the discharge curve, when the electricity price of second charge-discharge strategy is higher. The electronic device 100 can also adjust the charge-discharge curve of the second charge-discharge strategy to the charge curve, when the electricity price of second charge-discharge strategy is lower.

For example, if the user goes out three days later and the battery of the vehicle has a spare amount, the second charge-discharge strategy can charge the battery of the vehicle for several hours, and the electronic device 100 can adjust the second charge-discharge strategy. The vehicle can discharge when the electricity price is high, and supply electricity to household appliances 200. The second charge-discharge strategy is adopted to continue charging the battery of the vehicle, when the electricity price is lower.

After the first charge-discharge strategy is obtained, the electronic device 100 can perform block 204.

In block S204, the first charge-discharge strategy is transmitted to the charging pile 300, the charging pile 300 charges the vehicle based on the first charge-discharge strategy.

The operation behavior information of household appliance 200 can reflect the user's living habits, and the first driving travel time can be predicted according to the user's living habits, and the first charge-discharge strategy of the vehicle can be formulated according to the user's first driving travel time, the charge-discharge strategy of the vehicle is more intelligent to meet the user's needs. The second driving travel time can be predicted based on the operation data of the same type of household appliances 200. The operation data of the same type of household appliances 200 can reflect the same type of living habits. For example, getting up, washing, etc. The second driving travel time corresponding to different types of living habits can be predicted. The second driving travel times corresponding to different types of living habits are integrated to obtain the first driving travel time, the accuracy of the first driving travel time is improved.

The first charge-discharge strategy is combined the impact of the charge-discharge strategy on the battery life to guarantee the battery life.

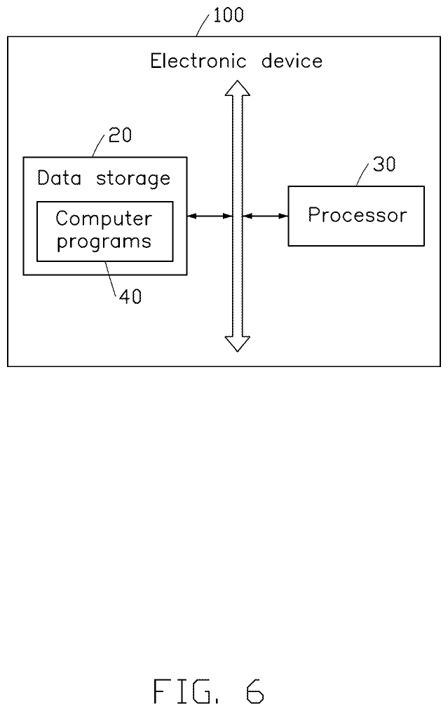

As shown in FIG. 6, one exemplary embodiment of an electronic device 100 comprises a data storage 20, at least one processor 30 and a computer program 40. The data storage 20 stores one or more programs which can be executed by the at least one processor 30. The data storage 20 is used to store instructions, and the processor 30 is used to call up instructions from the data storage 20, the computer programs 40 is stored in the data storage 20 and run on the processor 30, so that the electronic device 100 performs the steps of charge-discharge method in the above embodiment. The electronic devices 100 can be desktop computers, laptops, handheld computers, cloud servers, and other computing devices. The electronic devices 100 can interact with users through keyboard, mouse, remote control, touchpad, or voice control devices.

In one embodiment, a non-transitory storage medium recording instructions is disclosed. When the recorded computer instructions are executed by a processor of an electronic device 100, the electronic device 100 can perform the method.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A charge-discharge method applied to an electronic device, the electronic device communicates with a charging pile, the charge-discharge method comprising:
collecting operation behavior information of a user with respect to household appliances;
inputting the operation behavior information into a preset travel time prediction model to obtain a first driving travel time of the user;
determining a first charge-discharge strategy of a vehicle of the user based on the first driving travel time; and
transmitting the first charge-discharge strategy to the charging pile, wherein the charging pile charges the vehicle or controls the vehicle to discharge based on the first charge-discharge strategy.

2. The charge-discharge method of claim 1, wherein the operation behavior information comprises operation data of the user for operating the household appliances, the preset travel time prediction model is configured to:
obtain a type of a household appliance operated by the user of each of the operation data,
predict a second driving travel time corresponding to each type of the household appliances based on the operation data of the same type of the household appliances, and
determine the first driving travel time based on the second driving travel time corresponding to each type of the household appliances.

3. The charge-discharge method of claim 2, wherein predicting the second driving travel time corresponding to each type of the household appliances based on the operation data of the same type of the household appliances further comprises:
performing a driving travel time predicted based on each of the operation data to obtain a third driving travel time corresponding to each of the operation data;
classifying the third driving travel time to obtain driving travel time sets based on types of the household appliances of each of the operation data, wherein each of the driving travel time sets is corresponding to each type of the household appliances; and
combining the third driving travel time belonged to the same driving travel time set to obtain the second driving travel time.

4. The charge-discharge method of claim 2, wherein determining the first driving travel time based on the second driving travel time corresponding to each type of the household appliances further comprises:
obtaining a weight corresponding to each type of the household appliances; and
obtaining the first driving travel time based on the second driving travel time corresponding to each type of the household appliances and the weight corresponding to each type of the household appliances.

5. The charge-discharge method of claim 1, wherein the operation behavior information comprises operation data of the user for operating the household appliances, after collecting operation behavior information of a user with respect to household appliances, the method further comprises:
detecting whether the operation data is in a preset database, and marking a training state of the operation data as known information if the operation data is detected in the preset database, wherein the preset database comprises a sample for training the travel time prediction model;
marking the training state of the operation data as unknown information if the operation data is not detected in the preset database;
storing the operation data and the training state of the operation data in the preset database; and
retraining the travel time prediction model based on the operation data and the training state stored in the preset database.

6. The charge-discharge method of claim 1, wherein determining the first charge-discharge strategy of the vehicle based on the first driving travel time further comprises:
obtaining historical charge-discharge data of the vehicle;
inputting the historical charge-discharge data into a preset charge-discharge strategy formulation model to obtain a second charge-discharge strategy of the vehicle; and
adjusting the second charge-discharge strategy to obtain the first charge-discharge strategy based on the first driving travel time.

7. The charge-discharge method of claim 6, wherein the charge-discharge strategy formulation model is configured to:
predict multiple third charge-discharge strategies based on the historical charge-discharge data,
obtain a life improvement probability of each of the multiple third charge-discharge strategies for a battery of the vehicle,
screen objective charge-discharge strategies which meet a preset battery life improvement condition from the multiple third charge strategies based on the life improvement probability of each of the multiple third charge strategies, and
generate the second charge-discharge strategy based on the objective charge-discharge strategies.

8. The charge-discharge method of claim 6, wherein adjusting the second charge-discharge strategy to obtain the first charge-discharge strategy based on the first driving travel time further comprises:
obtaining a real-time electricity price; and
adjusting the second charge-discharge strategy to obtain the first charge-discharge strategy based on the first driving travel time and the real-time electricity price.

9. An electronic device, comprising:
at least one processor; and
a data storage storing one or more programs which when executed by the at least one processor, cause the at least one processor to:
collect operation behavior information of a user with respect to household appliances,
input the operation behavior information into a preset travel time prediction model to obtain a first driving travel time of the user,
determine a first charge-discharge strategy of a vehicle of the user based on the first driving travel time, and
transmit the first charge-discharge strategy to the charging pile, wherein the charging pile charges the vehicle or controls the vehicle to discharge based on the first charge-discharge strategy.

10. The electronic device of claim 9, wherein the operation behavior information comprises operation data of the user for operating the household appliances, the preset travel time prediction model is configured to:
obtain a type of a household appliance of operated by the user of each of the operation data,
predict a second driving travel time corresponding to each type of the household appliances based on the operation data of the same type of the household appliances, and
determine the first driving travel time based on the second driving travel time corresponding to each type of the household appliances.

11. The electronic device of claim 10, wherein when predicting a second driving travel time corresponding to each type of the household appliances based on operation data of the same type of household appliances, the at least one processor is further caused to:
perform a driving travel time predicted based on each of the operation data to obtain a third driving travel time corresponding to each of the operation data,
classify the third driving travel time to obtain driving travel time sets based on types of the household appliances of each of the operation data, wherein each of the driving travel time sets is corresponding to each type of the household appliances, and
combine the third driving travel time belonged to the same driving travel time set to obtain the second driving travel time.

12. The electronic device of claim 10, wherein determining the first driving travel time based on the second driving travel time corresponding to each type of the household appliances further comprises:
obtaining a weight corresponding to each type of the household appliances; and
obtaining the first driving travel time, based on the second driving travel time corresponding to each type of the household appliances and the weight corresponding to each type of the household appliances.

13. The electronic device of claim 9, wherein the operation behavior information comprises operation data of the user for operating the household appliances, after collecting operation behavior information of a user with respect to household appliances, the at least one processor is further caused to:
detect whether the operation data is in a preset database, and mark a training state of the operation data as known information, if the operation data is detected in the preset database, wherein the preset database comprises a sample for training the travel time prediction model,
mark the training state of the operation data as unknown information, if the operation data is not detected in the preset database,
store the operation data and the training state of the operation data in the preset database, and
retrain the travel time prediction model, based on the operation data and the training state stored in the preset database.

14. The electronic device of claim 9, wherein determining the first charge-discharge strategy of the vehicle based on the first driving travel time further comprises:
obtaining historical charge-discharge data of the vehicle;
inputting the historical charge-discharge data into a preset charge-discharge strategy formulation model to obtain a second charge-discharge strategy of the vehicle; and
adjusting the second charge-discharge strategy to obtain the first charge-discharge strategy based on the first driving travel time.

15. The electronic device of claim 14, wherein the charge-discharge strategy formulation model is configured to:
predict multiple third charge-discharge strategies based on the historical charge-discharge data,
obtain a life improvement probability of each of the multiple third charge-discharge strategies for a battery of the vehicle,
screen objective charge-discharge strategies which meet a preset battery life improvement condition from the multiple third charge strategies, based on the life improvement probability of each of the multiple third charge strategies, and
generate the second charge-discharge strategy based on the objective charge-discharge strategies.

16. The electronic device of claim 14, wherein adjusting the second charge-discharge strategy to obtain the first charge-discharge strategy based on the first driving travel time further comprises:
obtaining a real-time electricity price; and
adjusting the second charge-discharge strategy to obtain the first charge-discharge strategy, based on the first driving travel time and the real-time electricity price.

17. A non-transitory storage medium having stored thereon instructions that, when executed by a processor of an electronic device, causes the electronic device to perform a charge-discharge method, the charge-discharge method comprising:
collecting operation behavior information of a user with respect to household appliances;
inputting the operation behavior information into a preset travel time prediction model to obtain a first driving travel time of the user;
determining a first charge-discharge strategy of a vehicle of the user based on the first driving travel time; and
transmitting the first charge-discharge strategy to the charging pile, wherein the charging pile charges the vehicle or controls the vehicle to discharge based on the first charge-discharge strategy.
